(19) United States
(12) Patent Application Publication
(10) Pub. No.: US 2025/0051971 A1
(43) Pub. Date: Feb. 13, 2025

(54) A HIGH TENACITY REGENERATED CELLULOSIC FIBER

(71) Applicants: GRASIM INDUSTRIES LIMITED, UJJAIN (IN); NANOLLOSE LIMITED, NEDLANDS (AU)

(72) Inventors: DEEPIKA GUPTA, NAVI MUMBAI (IN); MANZOORAHMED SHAIKH, NAVI MUMBAI (IN); NITEEN DESHMUKH, NAVI MUMBAI (IN); PARAG PATIL, NAVI MUMBAI (IN); WAYNE MORRIS BEST, GOSNELLS (AU); KAREN JOY BREESE, APPLECROSS (AU); MADIAN MOHAMAD JINZARLI, PIARA WATERS (AU)

(73) Assignees: GRASIM INDUSTRIES LIMITED, UJJAIN (IN); NANOLLOSE LIMITED, NEDLANDS (AU)

(21) Appl. No.: 18/261,256

(22) PCT Filed: Jan. 11, 2022
(86) PCT No.: PCT/IB2022/050173

§ 371 Date: Jul. 12, 2023

(30) Foreign Application Priority Data
Jan. 12, 2021 (IN) 202111001298

(51) Int. Cl. D01F 2/02; C08B 1/00; D01D 1/02; D01D 5/06; D01F 1/02

(52) U.S. Cl. CPC D01F 2/02; C08B 1/003; D01D 1/02; D01D 5/06; D01F 1/02; D10B 2201/22; D10B 2401/063

(57) ABSTRACT

A high tenacity regenerated cellulosic fiber is disclosed. Said high tenacity regenerated cellulosic fiber is prepared from a cellulosic raw material, wherein the cellulosic raw material comprises 5-100 wt % of a pre-treated bacterial cellulose having a degree of polymerization in a range of 450-2000; and 0 to 95 wt % of an additional cellulosic material selected from a group consisting of dissolving grade pulp, recycled cotton pulp, reclaimed cellulosic material and a mixture thereof. Said fiber has a tenacity of at least 4.5 grams/denier and elongation of at least 10%, measured in accordance with ASTM D 3822.

### CROSS-REFERENCE TO RELATED APPLICATIONS

The present application is a national stage of International Application No. PCT/IB2022/050173, filed Jan. 11, 2022, and claims the priority to Indian Patent Application No. 201910176206.2, filed Jan. 12, 2021, each of which is incorporated by reference herein in its entirety

### FIELD OF INVENTION

The present disclosure relates to a high tenacity regenerated cellulosic fiber obtained from bacterial cellulose and a process for production of said fiber.

### BACKGROUND

It is known to produce fibers from wood pulp and other plant-based cellulose. While there are various potential sources of cellulose, the most used are all plant-based, where plant material is subjected to a time and energy consuming extraction process to produce cellulose pulp. For example, generating a cellulose pulp from wood necessitates barking and chipping trees before treating the wood chips with sodium hydroxide/sodium sulphide at elevated temperatures. Intensive forestry and the associated infrastructure are resource intensive and continues to pose a challenge in meeting the growing demand for cellulose feedstock in industry.

Bacterial cellulose (also known as microbial cellulose) offers an alternative and potentially more sustainable source of cellulose to traditional plant-based sources. Moreover, bacterial cellulose is readily obtained in much higher purity than plant-based cellulose which is typically contaminated with lignin and hemicellulose.

Bacterial cellulose is prepared using fermentation processes by a variety of bacteria, especially those from the genus—Acetobacter, Gluconobacter, Gluconacetobacter and Komagataeibacter, acting on a range of carbon sources such as carbohydrates and alcohols. Bacterial cellulose consists of an ultra-fine network of cellulose nanofibers (3-8 nm) which are highly uniaxially oriented. This type of 3D structure results in bacterial cellulose's higher crystallinity of about 60-80% and superior physico-chemical and mechanical properties.

The production of bacterial cellulose is well described in the literature, for example, Hestrin and Schramm, Biochemical Journal 1954, 58 (2), 345-352; Iguchi et al., Journal of Materials Science 2000, 35, 261-270; Wu and Li, Journal of Bioscience and Bioengineering 2015, 120 (4), 444-449; Basu et al., Carbohydrate Polymers 2019, 207, 684-693.

Bacterial cellulose finds application in various fields such as biomedical, food industry, paper making, cosmetics, and pharmaceutical. Currently, the fashion industry is becoming more and more ‘eco-driven’ and is promoting ‘sustainable clothing’. While textile fibers based on natural and renewable resources are eco-friendly as compared to traditional petroleum-based alternatives, they are more expensive and not without environmental impact. Regulatory and market forces are constantly demanding eco-friendly and cost-effective solutions. Bacterial cellulose is a promising eco-friendly and sustainable alternative for plant-based cellulosic fibers.

However, reports of bacterial cellulose being used to produce fibers are very limited. An efficient process for production of lyocell fibers using bacterial cellulose is yet to be developed.

Makarov et al, Fiber Chemistry, Vol. 51, No. 3, September, 2019 discloses making of cellulosic films by solid phase dissolution method. To enhance the dissolution of bacterial cellulose in NMMO and achieve an 8% solution, solid phase activation was required. Even after using the solid phase dissolution method in N-methylmorpholine-N-oxide (NMMO) monohydrate, complete dissolution of bacterial cellulose could not be achieved. Solution preparation time was also high at about 12 hours. Due to the high degree of polymerization, the resulting bacterial cellulose-NMMO solution had very high viscosity of about 10⁵ Pa·s which lead to difficulty in spinning fibers. High viscosity restricted bacterial cellulose concentration in NMMO to 6% and the cellulose fibers thus formed had a tenacity of only 3.8 g/d and elongation of 6.6%, significantly lower than that of standard lyocell fibers.

Shanshan et al., Carbohydrate Polymers Vol 87 (2012) pages 1020-1025 discloses making films from bacterial cellulose in NMMO by phase-inversion technique to achieve dissolution of as formed bacterial cellulose pellicles. The bacterial cellulose solution was prepared with as low as 3% bacterial cellulose content.

Gao et al., Carbohydrate Polymers 2011, 83 (3), 1253-1256, reported the use of bacterial cellulose with a degree of polymerisation of 2,700. Solubility in NMMO appeared to be challenging as dissolution was carried out for an extended dissolution time of 12 hours at 80° C. with fast energy intensive stirring to prepare the dope with a cellulose concentration of 7%. Moreover, the resulting fibers spun from this dope were having low tenacity of only 0.5-1.69 g/d as compared to typical lyocell fiber tenacity of around 4.0-4.4 g/d).

CN 101492837 B describes a method for preparing regenerated bacterial cellulose fibers having using bacterial cellulose having high degree of polymerization of 1500-16000, by dissolution in a suitable solvent such as an ionic liquid and prepare a solution in the range of 1-30%, followed by filtering and then spinning.

WO 00/23516 describes usage of bacterial cellulose with plant-based cellulose in a composition ranging from 0.01 to 5% in dissolved or undissolved form.

CN101230494 A describes the use of complex mixtures of different high and low degree of polymerization celluloses including ‘natural’ cellulose, bacterial Cellulose, kenaf, hemp, jute and flax, in combination with polyacrylonitrile. The cellulose mixtures and polyacrylonitrile are dissolved in ionic liquids, but not NMMO. Use of low and high degree of polymerization bacterial cellulose in combination with flax and polyacrylonitrile in 1-allyl-3-methylimidazolium chloride produced fibers with a tenacity of 2.6 g/d.

The prior known techniques of using bacterial cellulose find limited or no application in production of eco-friendly regenerated cellulosic fibers. Further, such processes face disadvantages such as low concentration of cellulose solution, longer dissolution time and high viscosity of cellulose solution. Additionally, the prior known fibers obtained using bacterial cellulose exhibit lower tenacity compared to standard lyocell fibers.

### SUMMARY

A high tenacity regenerated cellulosic fiber is disclosed. Said high tenacity regenerated cellulosic fiber is prepared from a cellulosic raw material, wherein the cellulosic raw material comprises 5-100 wt % of a pre-treated bacterial cellulose having a degree of polymerization in a range of 450-2000; and 0 to 95 wt % of an additional cellulosic material selected from a group consisting of dissolving grade pulp, recycled cotton pulp, reclaimed cellulosic material and a mixture thereof. Said fiber has a tenacity of at least 4.5 grams/denier and elongation of at least 10%, measured in accordance with ASTM D 3822.

A process for preparing said regenerated cellulosic fiber having a tenacity of at least 4.5 grams/denier and elongation of at least 10%, measured in accordance with ASTM D 3822 is also disclosed. Said process comprises the steps of: subjecting a bacterial cellulose to a pre-treatment step to obtain a pre-treated bacterial cellulose having a degree of polymerization in a range of 450-2000, said pre-treatment step comprising treatment of the bacterial cellulose with a pre-treatment agent selected from a group consisting of an oxidizing agent, an acid, an alkali and mixtures thereof; preparing a pre-mix by mixing cellulosic raw material comprising of 5-100 wt % of the pre-treated bacterial cellulose, and 0 to 95 wt % of an additional cellulosic material selected from a group consisting of dissolving grade pulp, recycled cotton pulp, reclaimed cellulosic material and a mixture thereof, based on total weight of cellulosic raw material with a solvent, followed by dissolution thereof in a dissolution equipment, to dissolve the cellulose and obtain a dope solution; and extruding the dope solution prepared through fine orifice followed by air gap spinning and regeneration in a spin bath to obtain the regenerated cellulosic fiber.

### DETAILED DESCRIPTION

To promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

As used herein, the term “bacterial cellulose” is intended to mean that the cellulose is prepared using fermentation processes by a variety of microbe, especially those from the bacteria of genus—Acetobacter, Gluconobacter, Gluconacetobacter and Komagataeibacter, acting on a range of carbon sources such as carbohydrates and alcohols. The bacterial cellulose used in the present disclosure was obtained from various commercial sources outside India.

As used herein, the term “tenacity” is intended to mean the ultimate (breaking) force of the fiber (in gram-force units) divided by the denier.

As used herein, the term “elongation” is intended to mean elongation at break.

In the broadest scope, the present disclosure relates to a high tenacity regenerated cellulosic fiber obtained from bacterial cellulose and a process for preparing said fiber. In particular, the present disclosure relates to a high tenacity regenerated cellulosic fiber prepared from a cellulosic raw material, wherein the cellulosic raw material comprises 5-100 wt % of a pre-treated bacterial cellulose having a degree of polymerization in a range of 450-2000; and 0 to 95 wt % of an additional cellulosic material selected from a group consisting of dissolving grade pulp, bamboo pulp, hemp, recycled cotton pulp, reclaimed cellulosic material and a mixture thereof, wherein the fiber has a tenacity of at least 4.5 grams/denier and elongation of at least 10%, measured in accordance with ASTM D 3822.

The present disclosure also provides a process for preparing aforesaid high tenacity regenerated cellulosic fibers. Said process comprises the steps of:
(a) subjecting a bacterial cellulose to a pre-treatment step to obtain a pre-treated bacterial cellulose having a degree of polymerization in a range of 450-2000, said pre-treatment step comprising treatment of the bacterial cellulose with a pre-treatment agent selected from a group consisting of an oxidizing agent, an acid, an alkali and mixtures thereof;
(b) preparing a pre-mix by mixing cellulosic raw material comprising of 5-100 wt % of the pre-treated bacterial cellulose, and 0 to 95 wt % of an additional cellulosic material selected from a group consisting of dissolving grade pulp, bamboo pulp, hemp, recycled cotton pulp, reclaimed cellulosic material and a mixture thereof, based on total weight of cellulosic raw material with a solvent, followed by dissolution thereof in a dissolution equipment, to dissolve the cellulose and obtain a dope solution; and
(c) extruding the dope solution prepared through fine orifice followed by air gap spinning and regeneration in a spin bath to obtain the regenerated cellulosic fiber.

The present inventors found that reducing the degree of polymerization of bacterial cellulose from its natural level (˜2500-10000) to an optimal degree of polymerization in the range of 450 to 2000, particularly in the range of 500-1500 enables manufacturing regenerated cellulosic fibers having high tenacity and elongation. Particularly, it was found that using bacterial cellulose having the optimized degree of polymerization enhances the dissolution thereof in solvents and a bacterial cellulose solution having a low viscosity and a high concentration of cellulose ˜9 to 15% could be obtained. This allows for the formation of regenerated cellulosic moulded bodies like fibers, having high tenacity and elongation.

In accordance with an embodiment, the pre-treated bacterial cellulose has the degree of polymerization in the range of 450-2000. In some embodiments, the pre-treated bacterial cellulose has the degree of polymerization in the range of 500-1500.

In accordance with an embodiment, to obtain the pre-treated bacterial cellulose the pre-treatment of bacterial cellulose is carried out using an acid selected from a group consisting of a mineral acid, an organic acid and their combination. The mineral acid includes sulphuric acid (H₂SO₄), hydrochloric acid (HCl), nitric acid (HNO₃) and phosphoric acid (H₃PO₄), and organic acids include but are not limited to oxalic acid, formic acid and acetic acid. In accordance with an embodiment, the pre-treatment is carried out using an oxidizing agent such as sodium hypochlorite. In accordance with an embodiment, the pre-treatment is carried out using an alkali including but not limited to sodium hydroxide, potassium hydroxide, ammonium hydroxide. In accordance with an embodiment, pre-treatment is carried out using a combination of one or more acid, alkali, and oxidizing agent for a further reduced degree of polymerization of the bacterial cellulose.

In accordance with an embodiment, the pre-treatment agent is used in a concentration ranging between 0.1 to 10%. In some embodiments, the concentration of the pre-treatment agent varies between 0.5 to 5%. The ratio of material to liquor (MLR) is maintained in a range of 8-40.

In accordance with an embodiment, the pre-treatment step comprises of an additional treatment for reducing the amount of metallic impurities such as iron (Fe) from the bacterial cellulose. The treatment is carried out to reduce the content of Fe to less than 20 ppm. In some embodiments, the treatment is carried out to reduce the content of Fe to less than 10 ppm. Said additional treatment comprises of treating the bacterial cellulose with a chelating agent. Any known chelating agent may be used. In accordance with an embodiment, the chelating agent is selected from a group consisting of ethylenediaminetetraacetic acid (EDTA), diethylenetriaminepentaacetic acid (DTPA) and diethylenetriamine penta (DTMPA). Said chelating agent is used in a concentration ranging from 0.1 to 0.8 wt % based on the weight of bacterial cellulose. The chelating agent is added before, during or after the addition of pre-treatment agent. Reducing the Iron content of the bacterial cellulose, reduces the degradation of NMMO solvent and allows the dissolution bacterial cellulose at elevated temperatures.

In accordance with an embodiment, the pre-treatment step is carried out at a temperature ranging between 30 to 100° C. In some embodiments, the pre-treatment step is carried out at a temperature ranging between 50 to 90° C. In accordance with an embodiment, the pre-treatment step is carried out for a duration ranging from 15 min to 20 hours. In some embodiments, the pre-treatment is carried out for the duration of 2.5 to 4.5 hours. The pre-treatment is carried out in one, two or multiple steps. Carrying out the pre-treatment in multiple steps allows controlled reduction in degree of polymerization as well as efficient removal of iron content.

In accordance with an embodiment, after the pre-treatment step, the pre-treated bacterial cellulose is subjected to a washing step. The washing step comprises of multiple washing with cold or hot demineralized water. In some embodiments, hot demineralized water is used.

In accordance with an embodiment, the pre-treated bacterial cellulose is further subjected to a size reduction step. Said size reduction step may be carried out in a high-speed mixer, ball mill, shredder and the like. The size reduction step facilitates dissolution of bacterial cellulose in the solvent in the step (b) of the process.

In accordance with an embodiment, the additional cellulose material is selected from a group consisting of dissolving grade pulp, reclaimed cellulosic material, recycled cotton and other plant-based cellulose pulps including bamboo and hemp. The additional cellulosic material is added in an amount ranging between 0 to 95 wt %. In accordance with an embodiment, said additional cellulosic material has a degree of polymerization ranging between 500-2000. Specifically, dissolving grade pulp having a degree of polymerization ranging between 500-700, and recycled cotton having a degree of polymerization ranging between 500-2000 prepared from purification of textile cotton waste, is used.

In accordance with an embodiment, in step (b) a pre-mix is prepared by mixing the cellulosic raw material with a solvent. Herein, the pre-mix is prepared by mixing cellulosic raw material with 65 to 80% (w/w) aqueous solvent, in required proportion under condition of temperature and pressure where no dissolution of cellulose takes place but where the cellulose absorbs the solvent uniformly. In accordance with an embodiment, the pre-mixing is carried out for a time-period between 0 to 6 hours. In some embodiments, pre-mixing time is maintained between 0-60 minutes and particularly between 10-40 minutes. During pre-mixing, the resulting mixture of pre-treated bacterial cellulose, the additional cellulosic material and the solvent is allowed to remain as such, with or without shear at a temperature between 25 to 90° C. This facilitates dissolution of cellulose in the solvent. The pre-mix is then subjected to high shear mixing at a temperature ranging between 90 to 110° C. followed by water evaporation at high temperature ranging between 90 to 115° C. and low pressure to remove excess water from the mixture resulting in a cellulose solution with a cellulose content of ˜9 to 15 wt %.

In accordance with an embodiment, the pre-mix further comprises an additive such as TiO₂, surfactant, pigments, carbon black etc.

In the next step, dissolution of pre-mix is carried out as per any standard lyocell process known in the art. In accordance with an embodiment, the dissolution is carried out by subjecting the pre-mix in the dissolution equipment to an elevated temperature ranging between 70-115° C., and particularly between 90-110° C. and under vacuum ˜500-750 mmHg. In accordance with an embodiment, the dissolution equipment is selected from a group consisting of sigma mixer, reactor kneader, wiped film evaporator and the like. The solvent is selected from a group consisting of N-methylmorpholine-N-oxide (NMMO), Ionic liquids, Dimethyl sulphoxide/Calcium chloride and Dimethyl acetamide/Lithium Chloride. In some embodiments, the solvent is NMMO.

In accordance with an embodiment, the dope solution obtained in step (b) has a viscosity ranging between 10² to 10⁴ Pa·s, measured using a typical oscillatory rheometer.

In the next step, the dope solution is extruded through suitable nozzles at a range of temperatures 105° C.±20° C. depending on the viscosity of the solution. The extruded solution is subjected to an air gap spinning and regenerated into the spinning bath. The spinning bath comprises of solvent in a concentration ranging between 5 to 30 wt % in water. The fibers are drawn off, optionally cut into staple fibers, washed, bleached, finished, dried.

In accordance with an embodiment, the obtained high tenacity regenerated cellulosic fibers have an average linear density in the range of 0.6-2.0 denier depending on flow and spinning speed.

It will be apparent to those skilled in the art that various modifications and variations can be made to the method/process of the present disclosure without departing from the scope of the disclosure. Other embodiments will be apparent to those skilled in the art from consideration of the specification and practice of the method/process disclosed herein. It is intended that the specification and examples be considered as exemplary only, with a true scope of the disclosure being indicated by the following claims and their equivalent.

### EXAMPLES

### Estimation of Degree of Polymerization (DP)

For pre-treated bacterial cellulose: The degree of polymerization of pre-treated bacterial cellulose is estimated by measuring the limiting viscosity of cellulose dissolved in dilute cupri-ethylene diamine (CED) solution as per the ISO standard number ISO 5351:2010. In said method, a known quantity of cellulose is dissolved in CED solution and viscosity of sample solution and solvent is measured using viscometer. The limiting viscosity is calculated as given in the ISO method. The degree of polymerization is estimated by an empirical formula as given in Eq [1]

$$DP = 1.7806 [ η ] - 94.7 \; 99 \qquad Eq [ 1 ]$$

Where [η] is the limiting viscosity and DP is Degree of Polymerization.

### Example 1: Separation of Bacterial Cellulose

Pellicles of bacterial cellulose were taken from nata de coco production and cleaned by physically scraping the thin film from the surface and washing the pellicle with water. Pellicles were approximately 36 cm×24 cm and had an average weight of 685 g when wet. After drying the resulting sheets of bacterial cellulose had an average weight of 7 g. The sheets (1 kg) were shredded through a cross-cut paper shredder to give small flakes (approximately 3 mm×8 mm) which were added to hot water (40 L at 90° C.) containing Tween 80 (0.4 L) and NaOH (0.9 kg) and stirred occasionally over a 15 minutes' period. The flakes were collected by filtration through a nylon mesh and pressed to remove any excess liquid. The flakes were then washed in hot water (40 L at 90° C.) for 15 minutes with occasional stirring. The flakes were again collected by filtration through nylon mesh, pressing to remove excess liquid. This wash cycle in hot water was repeated and the resulting flakes were added to water (40 L at room temperature). The pH was then adjusted to 6 by the addition of a 50% w/w sulphuric acid solution and stirred occasionally over a 15 minutes' period. The flakes were collected by filtration through a nylon mesh, pressed to remove any excess liquid and dried in a stream of warm air to give “bacterial cellulose flakes” with a DP of ˜1500 (limiting viscosity ˜873).

### Example 1a: Separation of Bacterial Cellulose

Pellicles of bacterial cellulose obtained from nata de coco production was cleaned by physically scraping the thin film from the surface and washing the pellicle with water. Pellicles were approximately 36 cm×24 cm and, on average, contained 7 grams of bacterial cellulose. Wet pellicles (100) were macerated in a blender for 3 minutes and the resulting pulp was placed into a nylon mesh bag inside a washing machine/spin dryer. Hot water (40 L at 90° C.) containing Tween 80 (0.4 L) and NaOH (0.6 kg) was added and the contents were stirred occasionally over a 15 minute's period. The excess liquid was then removed by spin drying. Hot water (40 L at 90° C.) was added to the machine and the contents were allowed to soak for 15 minutes with occasional stirring before again being spun dry. This wash/spin cycle was repeated and water (40 L at room temperature) was added. The pH was then adjusted to 6 by the addition of a 50% (w/w) sulphuric acid solution and stirred occasionally over a 15 minutes' period. The mixture was again spun dry to remove as much excess liquid as possible. The resulting pulp was removed from the nylon bag and formed into discs of approximately 22 cm diameter using a hydraulic press to remove any remaining excess liquid. The discs were dried in a stream of warm air and then shredded through a cross-cut paper shredder to give “bacterial cellulose chips” with DP˜2200 (limiting viscosity˜1300)

### Example 2: Pre-Treatment of Bacterial Cellulose Using NaOH

A mixture of 2% (w/w) bacterial cellulose flakes (as obtained in Example 1) was prepared in water and was treated with a 50% (w/w) NaOH solution to produce a final NaOH concentration of 10% (w/w) and cellulose loading of 1.6% (w/w). The reaction mixture was stirred at 60° C. for 16.2 hours and the solids were collected by vacuum filtration. The wet flakes were added to water in a w/v ratio of approximately 1:50 giving a basic mixture which was then neutralised with glacial acetic acid. The solids were then collected by vacuum filtration and dried in an oven overnight at 70° C. The DP of the material was found to be 706 (limiting viscosity 450 mL/g).

### Example 3: Pre-Treatment of Bacterial Cellulose Using NaOH

Bacterial cellulose flakes were pulped in water to provide a 2.0% (w/w) cellulose suspension. A 50% (w/w) NaOH solution was added to the pulp to give a final NaOH concentration of 18% (w/w) and cellulose loading of 1.3% (w/w). The reaction mixture was then stirred at 60° C. for 1 hour before the solids were collected by vacuum filtration and placed into a round bottom flask (approximately 25 mL per g of bacterial cellulose used) fitted with a rubber septa. This step resulted in decrease in the DP from 1500 to 973. The reaction using this pre-treated mixture was carried forward by submerging the flask in a water bath at 50° C. along with magnetic stirring for time intervals as mentioned in Table 1. After each time interval as shown in Table 1, water was added to the solid and the resulting basic mixture was neutralised with glacial acetic acid and vacuum filtered to isolate the solids which were washed with water before being dried in an oven overnight at 70° C. The resulting DP after each time interval is enumerated in Table 1.

TABLE 1
Limiting viscosity results for Example 3

| Hours | Limiting viscosity (mL/g) | DP |
|---|---|---|
| 0 | 600 | 973.6 |
| 1 | 361 | 548.0 |
| 1.5 | 339 | 508.8 |
| 2 | 331 | 494.6 |
| 2.25 | 292 | 425.1 |
| 3.17 | 252 | 353.9 |
| 3.5 | 258 | 364.6 |

### Example 4: Pre-Treatment of Bacterial Cellulose Using H₂SO₄

Water was added to bacterial cellulose flakes followed by the addition of sulphuric acid to produce a final concentration of 1% (w/w) sulphuric acid and a cellulose loading of 4% (w/w). The reaction mixture was then heated at 75° C. for the time interval specified in the Table 2. The solids were collected by vacuum filtration and then added to water in a w/v ratio of approximately 1:40 and the mixture was neutralised with 10% (w/w) NaOH solution. The solids were then collected by vacuum filtration and washed with water before being dried in an oven overnight at 50° C.

TABLE 2
Limiting viscosity results for Example 4

| Hours | Limiting viscosity (mL/g) | DP |
|---|---|---|
| 0.53 | 647 | 1057.3 |
| 1.27 | 516 | 824.0 |
| 2 | 434 | 678.0 |
| 2.93 | 407 | 629.9 |
| 5.08 | 358 | 542.7 |

### Example 5: Pre-Treatment of Bacterial Cellulose Using H₂SO₄

Weighed amount of bacterial cellulose with initial DP of ˜1500 (limiting viscosity of ˜873) and high Fe levels (38 ppm) was added to water in a material to liquor ratio of 1:30 as specified in Table 3, followed by the addition of sulphuric acid to produce a final concentration of 0.5% (v/v) sulphuric acid. The reaction mixture was then heated at 75° C. temperature, for 4 hours (Table 3). The solids were collected by vacuum filtration followed by addition to water in a w/v ratio of approximately 1:40 and the mixture was neutralised with 10% w/w NaOH solution. The solids were then collected by vacuum filtration and washed with water before being dried in an oven overnight at 50° C. The resultant DP and Fe content is enumerated in the Table 3.

### Example 6: Pre-Treatment of Bacterial Cellulose Using H₂SO₄

The process of Example 5 was used, but with a sulphuric acid concentration of 1% v/v, was given to the bacterial cellulose with initial DP of ˜1500. The resultant cellulose had a DP and Fe content of 830 and 20 ppm respectively and is enumerated in the Table 3.

### Example 7: Pre-Treatment of Bacterial Cellulose Using H₂SO₄

The process of Example 6 was used, but the temperature of treatment was increased to 85° C. and MLR was reduced to 1:25. The resultant cellulose had a DP and Fe content of 650 and 18 ppm respectively and is enumerated in the Table 3.

### Example 8 and 9: Pre-Treatment of Bacterial Cellulose Using Hydrochloric Acid

Bacterial Cellulose of DP ranging from ˜1600 to 2500 and average Fe content of ˜76 ppm was treated with HCL with concentration in the range of 0.5 to 1.5% (w/w) and MLR in the range of 1:10 to 1:13. The treatment temperature was kept at 75° C. and time of treatment was varied between 3 to 4 hours. Post treatment, the mixture was neutralized with 10% NaOH followed by washing, drying and shredding. The DP and Fe content of resultant cellulose is enumerated in Table 3.

TABLE 3
Pre-treatment of bacterial cellulose pulp with
acid for DP and Iron reduction

| | Example | Example | Example | Example | Example |
|---|---|---|---|---|---|
| | 5 | 6 | 7 | 8 | 9 |
| Treating Agent | H2SO4 | H2SO4 | H2SO4 | HCL | HCL |
| Conc. of treating | 0.5 | 1 | 1 | 0.5 | 1.5 |
| agent (% v/v) | | | | | |
| Treatment | 75 | 75 | 85 | 75 | 75 |
| Temp (° C.) | | | | | |
| Treatment | 4 | 3.5 | 3.5 | 4 | 3 |
| Time (h) | | | | | |
| MLR ratio (w/w) | 01:30 | 01:30 | 01:25 | 1:13 | 1:10 |
| Resultant limiting | 540 | 520 | 420 | 706 | 412 |
| viscosity (ml/g) | | | | | |
| DP | 866 | 830 | 650 | 1162 | 638 |
| Resultant Fe | 8 | 20 | 18 | 11 | 13 |
| (ppm) | | | | | |

### Examples 10 to 12: Pre-Treatment of Bacterial Cellulose Using Sodium Hypochlorite

Bacterial cellulose of DP ˜1500 and Fe content ˜56 ppm was treated with sodium hypochlorite at 1% w/w concentration with MLR of 1:15 for different durations at 60° C. as specified in Table 4. After the treatment, the bacterial cellulose was washed with boiling hot water 2-3 times followed by drying in air oven at 60° C. The resultant bacterial cellulose exhibited a reduced DP and Fe as shown in Table 4.

### Example 13: Pre-Treatment of Bacterial Cellulose Using Sodium Hypochlorite and EDTA

Bacterial cellulose of DP ˜1500 and Fe content ˜56 ppm was treated with sodium hypochlorite at 1% w/w concentration with MLR of 1:15 for 50 minutes, followed by treatment with 0.4 wt % (on the weight of dry pulp) EDTA solution for 30 minutes at 60° C. After the treatment, the bacterial cellulose was washed with boiling hot water 2-3 times followed by drying in air oven at 60° C. The resultant bacterial cellulose has a reduced DP and Fe as shown in Table 4.

TABLE 4
Treatment of Bacterial Cellulose with sodium hypochlorite

| | Example 10 | Example 11 | Example 12 | Example 13 |
|---|---|---|---|---|
| Treating | sodium | sodium | sodium | sodium |
| Agent | hypochlorite | hypochlorite | hypochlorite | hypochlorite + |
| | | | | 0.4% EDTA |
| Conc. of | 1 | 1 | 1 | 1 |
| treating | | | | |
| agent | | | | |
| (% w/w) | | | | |
| Treatment | 60 | 60 | 60 | 60 |
| Temp (° C.) | | | | |
| Treatment | 20 | 25 | 35 | 40 with |
| Time (min) | | | | hypo + |
| | | | | 30 min with |
| | | | | EDTA |
| MLR ratio | 01:15 | 01:15 | 01:15 | 01:15 |
| (w/w) | | | | |
| Resultant | 560 | 513 | 456 | 450 |
| limiting | | | | |
| viscosity | | | | |
| (ml/g) | | | | |
| DP | 900 | 818 | 717 | 706 |
| Resultant Fe | 40 | 42 | 45 | 19 |
| (ppm) | | | | |

### Example 14: Preparation of Fiber Using Dissolving Grade Pulp (DGP) (Control)

Cellulose solution is prepared from standard DGP with DP ˜600 as per the standard lyocell preparation process without any pre-mixing. The prepared dope was spun into fibers having Denier and Tenacity of 1.18 and 4.3 g/d respectively.

### Example 15: Preparation of Cellulose Solution Using Treated Bacterial Cellulose

Cellulose solution was prepared by pre-mixing the treated bacterial cellulose from Example 10 having a DP of 900 (limiting viscosity of 560 mL/g) and Fe content of 40 ppm, for 40 minutes, with dissolving grade pulp in 50% weight ratio, in NMMO. A solution with cellulose concentration of 12% was prepared in 76 wt % NMMO. The pre-mix comprising cellulose and NMMO was mixed for 40 minutes without stirring. After mixing, high shear was applied to prepare a cellulose—NMMO slurry at ˜100° C. The slurry was subjected to temperature ˜110° C. and 600 mmHg of vacuum for removal of water as per the Cellulose-NMMO phase diagram known in the art. The zero-shear viscosity of the resultant dope was found to be in the range of standard lyocell dope ˜10³ Pa·s.

### Example 16: Preparation of Cellulose Solution Using Treated Bacterial Cellulose

A cellulose solution was prepared by pre-mixing a sulphuric acid treated bacterial cellulose having a DP of 688 (limiting viscosity of 440 mL/g) and Fe content ˜20 ppm, for 40 minutes at a cellulose percentage of 12% by weight followed by dissolution as per the standard lyocell process. The resultant viscosity was found to be in the range of standard lyocell dope ˜10³ Pa·s.

### Example 17 to 21: Preparation of Cellulose Solution Using Treated Bacterial Cellulose

Cellulose solutions with 12.5% cellulose from sulphuric acid treated bacterial cellulose having a DP of 635 (limiting viscosity of 410 mL/g) and Fe content<10 ppm was prepared in NMMO with a short pre-mixing time of 30 minutes in different blend ratios ranging from 10 to 100 wt % with dissolving grade pulp of DP 600 (limiting viscosity˜390 mL/g).

In Example 20, fiber fine diners as low as 0.6 was prepared by increasing the stretch during the spinning of dope.

### Example 22: Preparation of Cellulose Solution Using Bacterial Cellulose Subjected to High Shear Mixing

12.5 wt % cellulose solution in NMMO was prepared from bacterial cellulose with DP of 1500 (limiting viscosity in the range 873) pre-treated in a high shear mixer where the said bacterial cellulose is mixed with excess water and thereafter the excess water is squeezed such that wet bacterial cellulose contains water that is 4-5 times the dry weight of bacterial cellulose. The wet pulp was blended with dissolving grade pulp (DP˜600) such that the ratio of wet bacterial cellulose is ˜10 wt % in the mixture. The said mixture was then used for preparation of cellulose solution as per the standard lyocell process.

### Example 23: Preparation of Cellulose Solution Using Treated Bacterial Cellulose

A 12.5 wt % cellulose solution is prepared by pre-mixing sulphuric acid treated bacterial cellulose having a DP of 653 (limiting viscosity of 420 mL/g) and Fe content˜10 ppm in a quantity of 40 wt % with 60 wt % recycled cotton pulp (DP˜650) for 30 minutes followed by dissolution as per the standard lyocell process explained earlier.

### Example 24: Preparation of Cellulose Solution from 100% Treated Bacterial Cellulose

A 12 wt % cellulose solution in NMMO was prepared from 100% bacterial cellulose treated with HCL and with a DP of ˜830 (limiting viscosity of 520 mL/g) as per the standard lyocell process explained earlier.

### Example 25: Preparation of Cellulose Solution Using Treated Bacterial Cellulose

A 12.5 wt % cellulose solution is prepared by pre-mixing hydrochloric acid treated bacterial cellulose having a DP of 520 (limiting viscosity of 340 mL/g) and Fe content˜17 ppm in a 40% weight ratio with 60 wt % recycled cotton pulp (DP˜650) for 40 minutes followed by dissolution as per the standard lyocell process explained earlier.

The bacterial cellulose solution formed in Examples 14-25 were extruded through suitable nozzles at a range of temperatures 105° C.±15° C. depending on the viscosity of the solution. The cellulose fibers were regenerated after passing through a spinneret and an air gap into the spinning bath, having the concentration of NMMO of 20 to 22% in water. The process details and properties of the fibers produced in Examples 14-25 have been summarized in Tables 5 & 6 below.

TABLE 5
Preparation of fiber from pre-treated bacterial
cellulose pulp, and properties thereof

| | Ex. 14 | Ex. 15 | Ex. 16 | Ex. 17 | Ex. 18 | Ex. 19 |
|---|---|---|---|---|---|---|
| Pre- | None | Hypochlorite | Acid | Acid | Acid | Acid |
| treatment | | | treatment | treatment | treatment | treatment |
| type | | | H2SO4 | H2SO4 | H2SO4 | H2SO4 |
| DP of | 0 | 900 | 688 | 635 | 635 | 635 |
| treated | | | | | | |
| Bacterial | | | | | | |
| Cellulose | | | | | | |
| % Cellulose | 12.5 | 12 | 12 | 12.5 | 12.5 | 12.5 |
| Bacterial | 0 | 50 | 100 | 10 | 20 | 50 |
| Cellulose | | | | | | |
| (%) | | | | | | |
| Pre-mix | 0 | 40 | 40 | 30 | 20 | 20 |
| time (min) | | | | | | |
| Spinning | 100 | 105 | 110 | 94 | 100 | 101 |
| temp (° C.) | | | | | | |
| Denier | 1.18 | 1.19 | 1.22 | 1.18 | 1.14 | 1.15 |
| Tenacity | 4.3 | 5.25 | 5.24 | 4.58 | 4.75 | 5 |
| (g/d) | | | | | | |
| Elongation | 14 | 12.68 | 11.69 | 12.21 | 11.47 | 12.99 |
| (%) | | | | | | |
| Young's | 98 | 128 | 129 | 101 | 114 | 109 |
| modulus | | | | | | |
| @1% strain | | | | | | |

TABLE 6
Preparation of fiber from pre-treated bacterial
cellulose pulp, and properties thereof

| | Ex. 20 | Ex. 21 | Ex. 22 | Ex. 23 | Ex. 24 | Ex. 25 |
|---|---|---|---|---|---|---|
| Pre- | Acid | Acid | high shear | Acid | Acid | Acid |
| treatment | treatment | treatment | mixing | treatment | treatment | treatment |
| type | H2SO4 | H2SO4 | | H2SO4 | with | with |
| | | | | | HCL | HCL |
| DP of | 635 | 635 | 1500 | 650 | 830 | 520 |
| treated | | | | | | |
| Bacterial | | | | | | |
| Cellulose | | | | | | |
| % Cellulose | 12.5 | 12.5 | 12 | 12.5 | 12 | 12.5 |
| Bacterial | 75 | 100 | 10 | 40 | 100 | 40 |
| Cellulose | | | | | | |
| (%) | | | | | | |
| Pre-mix | 20 | 40 | 10 | 30 | 20 | 40 |
| time (min) | | | | | | |
| Spinning | 102 | 99 | 104 | 99.5 | 104 | 101 |
| temp (° C.) | | | | | | |
| Denier | 0.72 | 1.18 | 1.1 | 1.15 | 1.15 | 1.17 |
| Tenacity | 5.7 | 5.27 | 4.71 | 5.37 | 5.12 | 4.65 |
| (g/d) | | | | | | |
| Elongation | 12.83 | 12.19 | 11.23 | 10.8 | 11.96 | 11.85 |
| (%) | | | | | | |
| Young's | 140 | 122 | 123 | 131 | 100 | 98 |
| modulus | | | | | | |
| @1% strain | | | | | | |

Observation: It was observed that the fibers produced using treated bacterial cellulose of present disclosure exhibited similar or higher tenacity as well as elongation as compared to tradition cellulosic fibers prepared from dissolving grade cellulose pulp.

### INDUSTRIAL APPLICABILITY

The disclosed high tenacity regenerated cellulosic fiber is obtained from bacterial cellulose and has similar or improved mechanical properties as compared to lyocell fiber prepared from dissolving grade pulp. The fiber is environment friendly and reduces the burden on plant-based sources of cellulose.

The disclosed process addresses the challenges of using bacterial cellulose for production of regenerated cellulosic fibers, and in particular, lyocell fibers. The disclosed process enables reducing the degree of polymerization of bacterial cellulose and hence the viscosity of the cellulose solution for manufacturing of fibers. The disclosed process enables reducing the degree of polymerization of bacterial cellulose along with reduction in the levels of metallic impurities. Reduction in degree of polymerization and the metallic impurities enhances the dissolution of bacterial cellulose in NMMO, making the resultant solution suitable for commercial production of lyocell fiber.

Also, the disclosed process requires a lower pre-mixing time as compared to that disclosed in the prior art.

The disclosed process enables preparing a cellulose solution with high percentage of bacterial cellulose˜9 to 15% with viscosity in spinnable range as measured using typical oscillatory rheometers. The disclosed process minimizes degradation of cellulose at elevated temperatures. Also, very fine denier lyocell fibers down to 0.6 denier, could be obtained.

1. A high tenacity regenerated cellulosic fiber prepared from a cellulosic raw material, wherein the cellulosic raw material comprises:
5-100 wt % of a pre-treated bacterial cellulose having a degree of polymerization in a range of 450-2000; and
0 to 95 wt % of an additional cellulosic material selected from a group consisting of dissolving grade pulp, bamboo pulp, hemp, recycled cotton pulp, reclaimed cellulosic material and a mixture thereof;
wherein the fiber has a tenacity of at least 4.5 grams/denier and an elongation of at least 10%, measured in accordance with ASTM D 3822.

2. The fiber as claimed in claim 1, wherein the pre-treated bacterial cellulose has the degree of polymerization in the range of 500-1500.

3. The fiber as claimed in claim 1, wherein high tenacity regenerated cellulosic the fiber has an average linear density in a range of 0.6-2.0 denier.

4. A process for preparing a high tenacity regenerated cellulosic fiber having a tenacity of at least 4.5 grams/denier and elongation of at least 10% measured in accordance with ASTM D 3822, said process comprising the steps of:
(a) subjecting a bacterial cellulose to a pre-treatment step to obtain a pre-treated bacterial cellulose having a degree of polymerization in a range of 450-2000, said pre-treatment step comprising treatment of the bacterial cellulose with a pre-treatment agent selected from a group consisting of an oxidizing agent, an acid, an alkali and mixtures thereof;
(b) preparing a pre-mix by mixing cellulosic raw material comprising of 5-100 wt % of the pre-treated bacterial cellulose, and 0 to 95 wt % of an additional cellulosic material selected from a group consisting of dissolving grade pulp, recycled cotton pulp, reclaimed cellulosic material and a mixture thereof, based on total weight of cellulosic raw material with a solvent, followed by dissolution thereof in a dissolution equipment, to dissolve the cellulose and obtain a dope solution;
(c) extruding the dope solution through fine orifice followed by air gap spinning and regeneration in a spin bath to obtain the regenerated cellulosic fiber.

5. The process as claimed in claim 4, wherein the pre-treated bacterial cellulose obtained in step (a) has the degree of polymerization in the range of 500-1500.

6. The process as claimed in claim 4, wherein the pre-treatment step comprises of an additional treatment for reducing the amount of metallic impurities in the bacterial cellulose, said treatment comprising treating the bacterial cellulose with a chelating agent.

7. The process as claimed in claim 4, wherein the pre-treatment agent is an oxidizing agent selected from a group consisting of sodium hypochlorite, potassium hypochlorite, hydrogen peroxide, ozone and a combination thereof.

8. The process as claimed in claim 4, wherein the pre-treatment agent is an acid selected from a group consisting of sulphuric acid (H₂SO₄), hydrochloric acid (HCl), nitric acid (HNO₃) and phosphoric acid (H₃PO₄), oxalic acid, formic acid, acetic acid and a combination thereof.

9. The process as claimed in claim 4, wherein the pre-treatment agent is an alkali selected from a group consisting of sodium hydroxide, potassium hydroxide, ammonium hydroxide and a combination thereof.

10. The process as claimed in claim 4, wherein the chelating agent is selected from a group consisting of ethylenediaminetetraacetic acid (EDTA), diethylenetriaminepentaacetic acid (DTPA) and diethylenetriamine penta (DTMPA).

11. The process as claimed in claim 4, wherein the pre-treatment step is carried out at a temperature ranging between 30 to 100° C. for a time-period ranging from 1 to 20 hours.

12. The process as claimed in claim 4, wherein after the pre-treatment step, the pre-treated bacterial cellulose is subjected to a washing step.

13. The process as claimed in claim 4, wherein the pre-treated bacterial cellulose is subjected to a size reduction step.

14. The process as claimed in claim 4, wherein the pre-mix is prepared by mixing the cellulosic raw material and the solvent in step (b), for a time-period between 0 to 6 hours, with or without shear at a temperature between 25 to 90° C.

15. The process as claimed in claim 4, wherein the solvent is selected from a group consisting of N-methylmorpholine-N-oxide (NMMO), Ionic liquids, dimethyl sulphoxide/calcium chloride and dimethyl acetamide/lithium chloride.

16. The process as claimed in claim 4, wherein the pre-mix further comprises an additive selected from a group consisting of TiO₂, surfactant, pigments and carbon black.
